(19) United States
(12) Patent Application Publication
(10) Pub. No.: US 2023/0229032 A1
(43) Pub. Date: Jul. 20, 2023

(54) A BEAM SHAPING DEVICE WITH IMPROVED PERFORMANCE

(71) Applicant: LENSVECTOR INC., San Jose, CA (US)

(72) Inventors: Tigran GALSTIAN, Quebec (CA); Armen ZOHRABYAN, Quebec (CA); Simon CAREAU, Quebec (CA)

(21) Appl. No.: 17/997,747

(22) PCT Filed: May 4, 2021
(86) PCT No.: PCT/CA2021/050621

§ 371 Date: Nov. 2, 2022

Related U.S. Application Data
(60) Provisional application No. 63/080,519, filed on Sep. 18, 2020.
(60) Provisional application No. 63/019,707, filed on May 4, 2020.

(51) Int. Cl. G02F 1/133; G02B 27/00; G02B 27/28

(52) U.S. Cl. CPC G02F 1/13306; G02B 27/0068; G02B 27/286; G02F 2203/07

(57) ABSTRACT

Liquid crystal (LC) beam control devices using a dispersion shaped (DS) half wave plate (HWP), with specific physical characteristics, allows the broadened beam to maintain significantly better the color cohesion. Beneficial aspects of using a HWP with an appropriate thickness and birefringence index which makes it inefficient in the blue wavelength spectrum, therefore reducing the blue photon depletion in the center of the broadened beam is described herein. Combinations of an homeotropic LC cell and DS HWP structures for reduced color separation, faster relaxation time and reduced ground state scattering is further described herein.

### CROSS-REFERENCE TO RELATED APPLICATIONS

This patent application claims priority of U.S. provisional patent applications 63/019,707 filed May 4, 2020 and 63/080,519 filed Sep. 18, 2020, the contents of which are hereby incorporated by reference.

### TECHNICAL FIELD

This patent application relates to liquid crystal beam control devices and particularly to the reduction of color separation in broadened beams.

### BACKGROUND

Liquid crystal (LC) beam control devices are known in the art. Some such devices use patterned electrodes over LC cells to arrange the alignment of LC molecules inside the cell. By varying the alignment of LC molecules to a desired orientation, the effective index of refraction of the material is locally modified and may thus control a beam of light passing through the cell. While it may be beneficial to use such devices to control a beam of light, there is a number of problems that impact their uses. Such problems may be a limited degree of angular control, poor quality of the beam's intensity distribution, excessive angular color separation, etc.

Many specific applications using “smart” lighting systems would benefit from using LC beam control devices. For example, Light Emitting Diode (LED) lighting sources are increasingly used in architectural lighting and the automotive industry. However, in a majority of cases, the parameters of those illumination systems (diffusion, divergence, glares, direction, etc.) are fixed. The ability to dynamically control some or all of these parameters without any mechanical or electromechanical systems have clear advantages (e.g. reduced complexity, easier maintenance, etc.). An example of a device which would significantly benefit from such LC beam control devices is an automobile lighting system with automatic divergence control when it senses a car moving in the opposed direction, so as to avoid disturbing the other driver. Further examples include residential and architectural lighting as well as Li-Fi technologies, which may require steerable light and the ability to focus/broaden the light source.

However, before the current LC beam control devices may be optimally used for certain applications, some underlying issues need to be addressed. One such issue is the angular color separation introduced by the broadening of a light beam by an LC device. This underlying issue of a standard multiple LC cells setup, acting on the different directions for both polarizations, results in an uneven white color throughout the broadened beam. Typically, the center of the broadened beam would have a reduced blue versus red photons compared to the rest of the broadened beam. This is generally due to the birefringence of usual LC materials, which is higher in the short wavelength (blue) spectrum. This higher birefringence may thus cause a chromatic aberration: more blue photons will be affected by the operation of LC cells than what is experienced by the green and red photons (i.e. more blue photons will be broadened than red and green).

This issue is particularly important in the case of architectural lighting, as the broadened light beam will have an undesired change of light color between the middle (center) and the sides (periphery) of the beam. This variation in color is typically significant enough to be visually perceptible and therefore prevent the use of LC beam control devices in some applications, which may otherwise be beneficial.

### SUMMARY

The applicant has discovered that using a dispersion shaped (DS) half wave plate (HWP), with specific (unusual) physical characteristics, in the center of a multiple LC cell setup allows the broadened beam to maintain significantly better color cohesion. Applicant found that selecting a HWP material with a specific thickness and birefringence index, which makes it less efficient for polarization rotation in the blue wavelength spectrum, reduces the blue photon depletion in the center of the broadened beam when used with a standard LC beam broadening cells that usually broaden blue better than green and red light. This necessarily results in lower color change in the center of the beam and thus better preservation of the so-called correlated color temperature (CCT) in the center of the beam. Furthermore, as the blue photons are less dispersed to the sides of the broadened beam, the perception of color separation between the center of the broadened beam and the remaining broadened beam is reduced.

The applicant has further found that by using this DS HWP in combination with a homeotropic oriented LC cell structure allowed the resulting LC device to not only reduce the color change and separation but to further reduce the ground state scattering of the light beam.

Moreover, the applicant has discovered that further using internal electrodes on both sides of each LC cell, with the DS HWP and the homeotropic LC alignment, allowed to address the issue of slow relaxation time while also ensuring better CCT cohesion and reduced ground state scattering.

LC-LC beam control devices using a DS HWP, with specific physical characteristics, allows the broadened beam to maintain significantly better color cohesion. Beneficial aspects of using a HWP with a width and birefringence index which makes it inefficient in the blue wavelength spectrum, therefore reducing the blue photon depletion in the center of the broadened beam is described herein. Combinations of LC cell and DS HWP structures for reduced color separation, faster relaxation time and reduced ground state scattering is further described herein.

The Half Wave Plate (HWP) can take the form of a single film, such as a polycarbonate-based polymer film as is known in the art. It can also be made in the form of two quarter wave plates, possibly slightly tilted one with respect to each other to manage dispersion properties of the assembly. The role of the HWP can be also played by a 90-degree twisted liquid crystal layer to ensure a broad band polarization rotation. With a liquid crystal-based HWP, it can be electrically controlled to allow switching ON and OFF the rotation of the polarization for additional control. In all cases, the HWP is selected to have an efficiency of polarization rotation that complements the color separation of the beam broadening LC modulation device so as to provide better preservation of the so-called correlated color temperature (CCT) in the center of the beam.

In some embodiments, there is provided a LC beam modulation device having at least one tunable LC cell having an anisotropic (polarization sensitive) LC material whose index of refraction is variable within the visible spectrum such that beam modulation has a first wavelength dependence, and a polarization rotation element having a second wavelength dependence of efficiency of rotation that is contrary to the first wavelength dependence. The polarization rotation element may be a HWP, and the LC beam modulation device may comprise at least two tunable LC cells arranged on opposite sides (before and after) of the HWP.

In some embodiments, the at least one tunable LC cell contains homeotropically aligned LC material and an arrangement of electrodes that, when powered, cause the LC molecules to be reoriented changing thus the effective refractive index distribution in that cell.

In other embodiments, the polarization rotation element is a quarter wave plate, and the device further comprises a reflector for reflecting light passing through the quarter wave plate back through the quarter wave plate and then back through the at least one tunable LC cell.

In some embodiments, the device is configured to broaden a light beam, while in others it can do beam steering or focusing. The device can be configured to broaden the light beam in all directions, in one specific direction, or in two perpendicular directions simultaneously, or in a selected one of two directions.

### BRIEF DESCRIPTION OF THE DRAWINGS

The invention will be better understood by way of the following detailed description of embodiments of the invention with reference to the appended drawings, in which:

FIG. 1A is a schematic diagram of a prior art LC beam control device comprising four LC cells with in-plane ground state orientation of local average orientation of its molecules (the so called, director n, is parallel to the surfaces of cell substrates);

FIG. 1B is a schematic of a prior art LC beam control device comprising four LC cells with a dynamic (electrically controllable) polarization rotator between each set of two LC cells;

FIG. 1C is a schematic of an exemplary prior art setup of a LC beam control device with a light source, a reflector/collimator and a dynamic LC beam shaper;

FIG. 1D is a graph illustrating the loss of CCT, at the center of the broadened beam, for different broadening degrees of the beam (corresponding to different excitation levels of LC cells);

FIG. 2 is an illustration of an exemplary HWP with a birefringence constant (Δn) and a given thickness (L);

FIG. 3A is a graph illustrating a numerical example of an HWP efficiently operating in the blue light spectrum;

FIG. 3B is a graph illustrating a numerical example of an HWP efficiently operating in the green light spectrum;

FIG. 3C is a graph illustrating a numerical example of an HWP efficiently operating in the red light spectrum;

FIG. 4 is a schematic of an exemplary LC beam control device comprising two homeotropic LC cells having “finger” (linear, interdigitated) electrodes only on one of their inner surfaces and these electrodes have perpendicular orientations for different cells and a HWP that is placed between these two cells;

FIG. 5 is a schematic of an exemplary LC beam control device comprising two homeotropic LC cells having “finger” (linear, interdigitated) electrodes only on one of their inner surfaces and these electrodes have parallel orientations for different cells and a HWP that is placed between these two cells;

FIG. 6 is a schematic of an exemplary LC beam control device comprising four of above-mentioned homeotropic LC cells (two sets of two cells), each set of two having perpendicular electrodes directions, and a central HWP;

FIG. 7 is a schematic of an exemplary LC beam control device comprising two homeotropic LC cells, each having finger (linear, interdigitated) electrodes on one substrate and a uniform transparent electrode on the substrate of the opposing side of the same LC cell, and a center HWP;

FIG. 8 is a schematic of an exemplary LC beam control device comprising two homeotropic LC cells, each having finger (linear, interdigitated) electrodes on both substrates on opposing side of the same LC cell, and a center HWP;

FIG. 9 is a graph illustrating the reduction in scattering between a prior art “classic” device (with planar oriented LC) and the proposed design in this application, throughout the visible light spectrum;

FIG. 10 is a schematic of an exemplary LC beam control device comprising two homeotropic LC cells having perpendicular finger (linear, interdigitated) electrode directions, a quarter wave plate and a reflector for operation in a reflection mode;

FIG. 11 is a schematic of an exemplary LC beam control device comprising two homeotropic LC cells each having two substrates with perpendicular finger (linear, interdigitated) electrode directions, a half wave plate between the two homeotropic LC cells and a rotation in the alignment of the second homeotropic LC cell;

FIGS. 12A through 12F are illustrations of beam broadening in different directions as produced by an exemplary LC beam control device; and

FIG. 13 is a schematic of an exemplary LC beam control device comprising two homeotropic LC cells each having two substrates with dual perpendicular electrode zones.

### DETAILED DESCRIPTION

As described in the prior art, beam control devices are optical devices that control a refracted output beam of light either with respect to the beam divergence or with respect to the beam direction. Controlled beam divergence is a special case of beam control providing beam focusing and defocusing. Beam direction control may be employed for beam steering purposes. Beam control devices that provide a combination of beam diffusion, beam divergence/convergence or beam direction control are generally referred to herein as beam shaping devices.

In liquid crystal (LC) beam control devices, an electric field is typically used to control a molecular orientation in a LC cell. The electric field may be modulated (in time and space) by powering preferably transparent electrodes on one or each side of an LC cell, such that the resulting electric field modulates the orientation of LC molecules as desired. The change in molecular orientation affects the local index of refraction of the LC and may create a refractive index gradient throughout the LC volume (both in lateral/transversal and longitudinal directions).

Nematic LCs usually can affect a single polarization component of incident unpolarized light. Therefore, to modulate unpolarized light, two or more orthogonally oriented layers of LC are commonly used. Natural or unpolarized light may be considered as being composed of two orthogonal polarizations, one of which would be modulated by a first LC layer while the second (perpendicular) polarization would be modulated by a second LC layer. Additional LC layers may be used when part of the LC device (e.g. a half wave plate (HWP)) provides a rotation of the linear polarization's plane, such that the additional LC layers may act on different polarization planes.

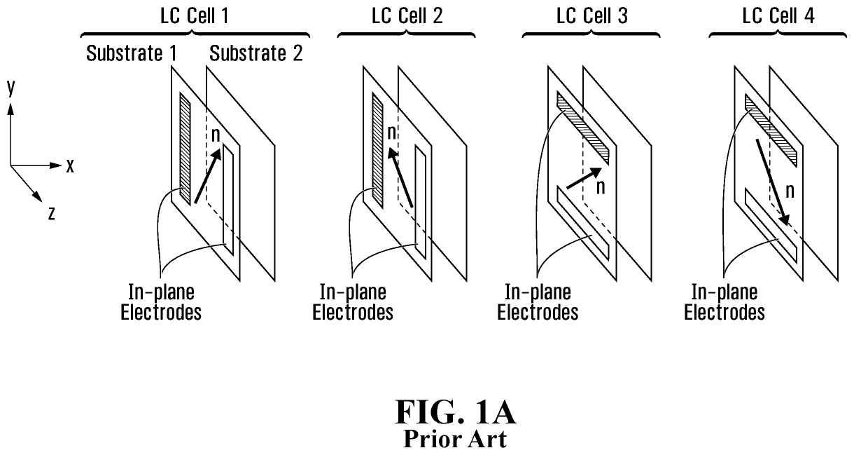

Now referring to FIG. 1A, which is a schematic of a prior art LC beam control device comprising four LC cells with in-plane orientations of their directors n. This embodiment is composed of 4 cells (each cell being composed of 2 substrates and a LC material inside). The director n of the LC material in each cell is in the plane of substrates (shown by a tilted bold black arrow in each cell). The unit of so called “in-plane-switch” parallel (or finger or interdigitated) linear electrodes (filled blue and empty rectangles) on various substrates is also shown with respect to the “planar” alignment of molecules (at +45 or −45 degrees with respect to in-plane electrodes). In this particular case, the electrodes are only on the first substrate of each cell and there are no electrodes on the second substrate.

In this configuration, light propagates from left to right, in the direction of +x axis. The two perpendicular polarizations of the light beam, along the y and z axes, can thus be transformed by the combination of multiple cells. Depending on the type of the desired transformation, the electrodes of selected LC cells may be activated (i.e. not all cells need to be activated for the device to broaden a beam of light in one plane).

As described herein, using such configuration of LC device results in several problems (color separation and color change, slow relaxation and high ground state scattering of light).

These may all be related to the same factor: the fact that the director n is aligned in the plane of substrates. Among others, this makes the dispersion of the LC material (perceived by the incident light) and the scattering of light very high. In addition, the natural relaxation of molecular reorientation is required to come back to the unperturbed state (in the plane of substrates).

FIG. 1B illustrates another embodiment of a prior art LC beam control device, which uses a configuration of four LC cells and a polarization rotator at the center of the setup. In this prior art embodiment, the rotator (e.g. a HWP) may be dynamically controlled or may be a passive element. Using this configuration allows the LC device to broaden a beam of light in a vertical or horizontal line if only one pair of LC cells is powered. It may also broaden the beam in the two directions when all cells are powered. In these applications, the polarization rotator is typically chosen to rotate the light waves at 90 degrees and it must be as broadband as possible, such that the second pair of LC cells may broaden the polarization of light that was not broaden by the first pair of LC cells.

Compared to the in-plane average molecular arrangement of FIG. 1A, the embodiment of FIG. 1B is also described, in the prior art, as alternatively working for LC cells employing homeotropic alignment. However, this configuration of LC cells with a rotator does not address the issue of color separation and color change in the broadened beam.

FIG. 1C is a schematic of an exemplary prior art setup of a LC beam control device with a light source (typically a Diode laser or LED pumping a layer of phosphor), a reflector (or a base lens) for light collimation and a dynamic LC beam shaper to broaden the beam of light. As described above, and without any variable control of the light source (e.g. controlling the ratio of blue/green/red photons), the resulting beam would generally present significant color separation. The color change (in the center of the beam) as a function of broadening level for such prior art devices is illustrated in the graphic of FIG. 1D.

FIG. 1D demonstrates the loss of correlated color temperature (CCT) in the center of the broadened beam for different degrees of broadening. CCT is a well-known method to represent perceived colors most closely resembling that of a given stimulus at the same brightness and under specified viewing conditions. Typical values of color temperature in the visible light spectrum are over 5000 K for blueish (“cold”) colors, in the range of 2700-3000 K for yellowish colors and lower than 1500 K for reddish (“warm”) colors.

As such, the CCT loss illustrated in FIG. 1D, which varies from 0 K when the LC broadening device is not powered to 300 K for a broadening of more than 20 degrees, is significant. In architectural lighting applications, a lower color temperature light (i.e. “warmer light”) is often used in spaces to promote relaxation whereas a higher color temperature light (i.e. “cooler light”) is often used in spaces to enhance concentration. The choice of a specific color temperature lighting for a designed space is thus important and devices providing beam control to the lighting system should not visibly change the color of the light (ideally the change should be less or at the order of 50 k). The issue may also be worsened by the fact that prior art LC broadening devices typically have this color change primarily at the center of the broadened beam and not on the surrounding light. The color change may thus be easier to visually identify as the color of the beam is not constant for each light source.

The applicant has discovered that in dynamic lighting applications (such as the prior art embodiment of FIG. 1B), the short λ (blue light) is more affected (by the broadening of the LC device) than the large λ (red light). This is the reason why a “depletion” of blue light in the center of the broadened beam is observed, and therefore this is the main reason for the color change. The applicant has further discovered that, in contrast to standard broadband HWP, using a HWP that is designed to operate mainly for green and/or red light may significantly reduce the above-mentioned problem of CCT change. In this case, the HWP may not operate as a “good HWP” for the blue light (short λ). In other words, the polarization of these short wavelengths will not be completely rotated (it will be partially rotated and partially transformed from a linear to elliptical polarization) and thus, it will not be further broadened efficiently by the following the HWP LC cells (in the extreme case example, there will be no more broadening by the following cells if there is not polarization rotation at all by the HWP). Thus, these short wavelengths will be less broadened and there will be less depletion of blue light in the center of the beam. Therefore, the CCT will not be strongly affected if this process is equilibrated with the LC device's broadening process (chromatic dispersion due to the LC's birefringence).

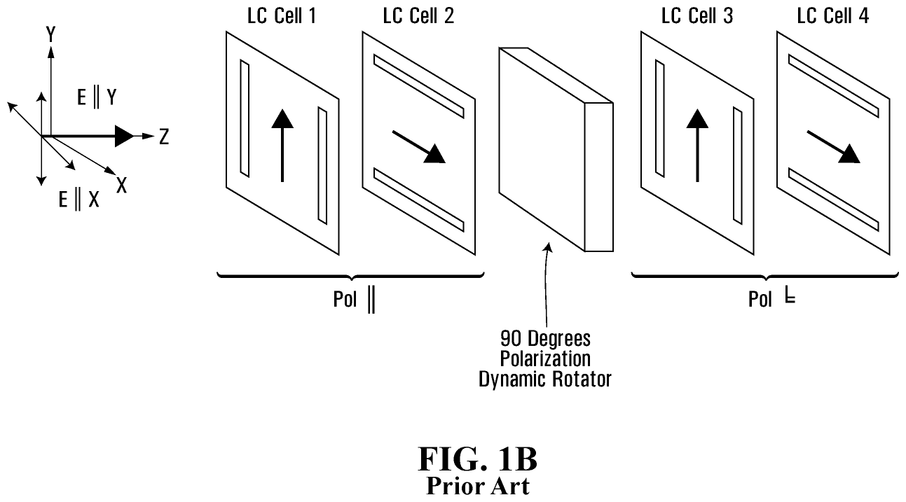

FIG. 2 is an illustration of an exemplary film of HWP with an optical birefringence (Δn) and a given thickness (L) of its material. It is important to notice that the material of the HWP also usually has its own dispersion. As described herein, using an HWP material with an appropriate choice of thickness and birefringence (and its dispersion), such that the HWP is not efficient in the blue light wavelength spectrum, allows for the reduction the CCT change in a broadening LC device. The film of the HWP has a birefringence (Δn) and two polarization modes (ordinary and extraordinary) of light propagation with a relative phase delay G=2πLΔn/λ; where λ is the light wavelength in the vacuum, L is the thickness of the birefringent film, Δn is its birefringence value that depends upon λ due to the natural dispersion of the material.

If the value of G is equal to π (3.14 rad) or π+2π*m (where m=0; 1, 2, 3, . . . ) then the HWP rotates the input light's linear polarization plane (while keeping the polarization state as linear). Thus, if the input polarization's plane is oriented at 45 degrees (with respect to the birefringence axis of the HWP), then the linear polarization plane of the output beam will be oriented at −45 degrees (thus, we have a flip of 90 degrees). Otherwise, when G≠π, the film will not act like an HWP and it will deform the polarization state (e.g., from linear to elliptical) instead of rotating it.

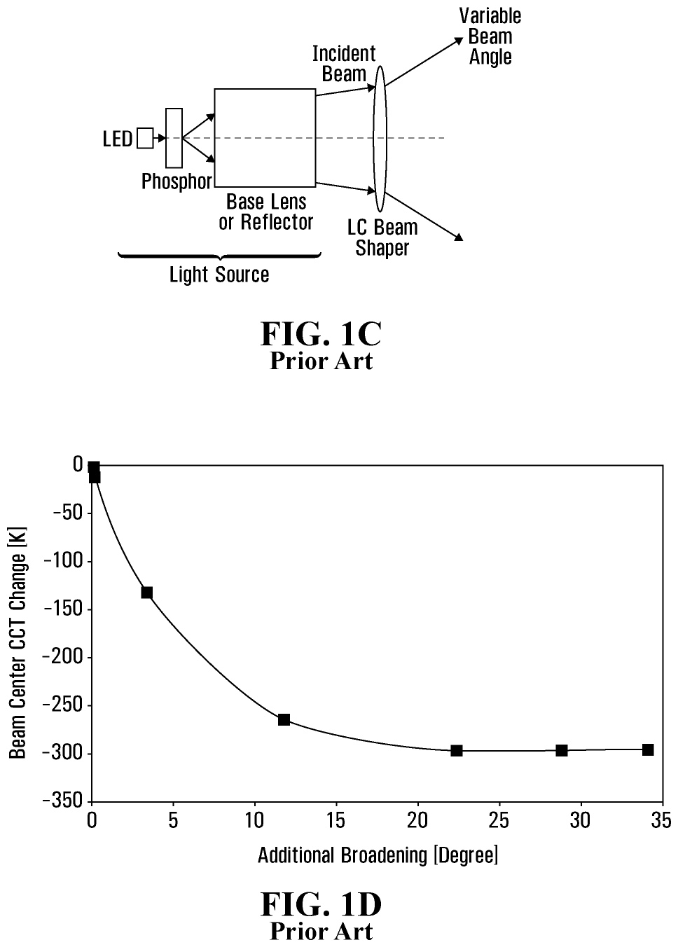

In all known applications of the HWP, scientists and engineers try to obtain a curve of G versus light wavelength λ (see FIGS. 3A to 3C) that is spectrally as flat as possible to maintain the condition G≈π for all λ. This represents what is called an ideal “broad band” operation (the flatter the HWP is, the more expensive it is; there are “low order” and “high order” HWPs with various λ dependences).

FIGS. 3A, 3B and 3C present graphs illustrating 3 cases of simulated material choices of HWP's material (birefringence versus wavelength) that show curves for typical HWPs. FIG. 3A operates as a good HWP for the blue light (wavelengths between 0.35 um and 0.45 um, denoted by the dashed rectangle). FIG. 3B operates as a good HWP for the green light (wavelengths between 0.45 um and 0.55 um) and FIG. 3C operates as a good HWP for red light (wavelengths between 0.56 um and 0.7 um).

Therefore, the HWP may be shaped in a way to compensate the loss of blue light. For example, in an extreme case, if the HWP rotates only green and red light (but not the blue light), then only half of the incident (original) natural unpolarized blue light will be broaden (by the first LC cells), while the other half that light will go through the system without broadening. As such, this would result in significantly more blue light remaining in the center of the beam, while both green and red light will undergo 100% broadening (with both of their polarization components being broadened). A DS HWP thus allows the control of the CCT of the device by the choice of the dispersive properties of both the LC cells and the birefringence and thickness of the HWP's material used.

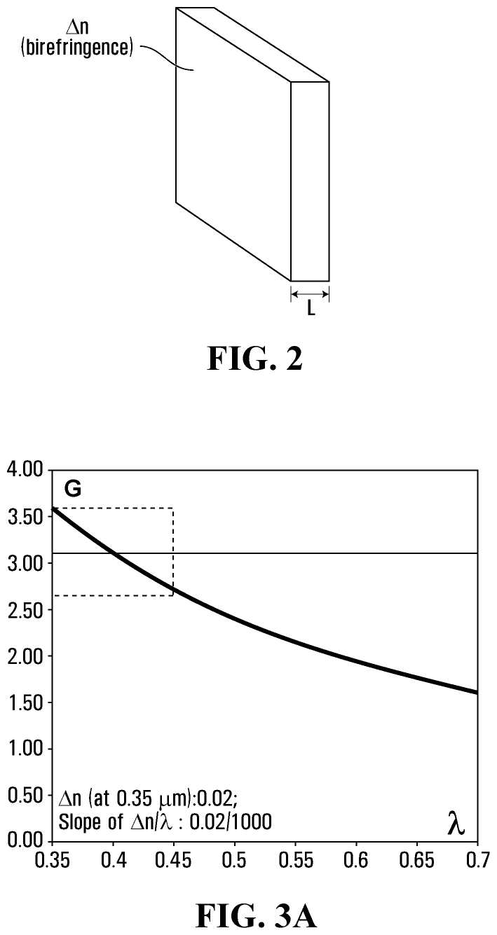

Reference is now made to FIG. 4, which illustrates an exemplary LC beam control device comprising two homeotropic LC cells with perpendicular electrodes 35, 37 directions and a center HWP 39. As described herein, using a homeotropic aligned LC (the director n is perpendicular to the cell substrates 31, 33, as shown by the bold arrows n) improves the performance of LC beam control devices such as the embodiment described in FIG. 1A.

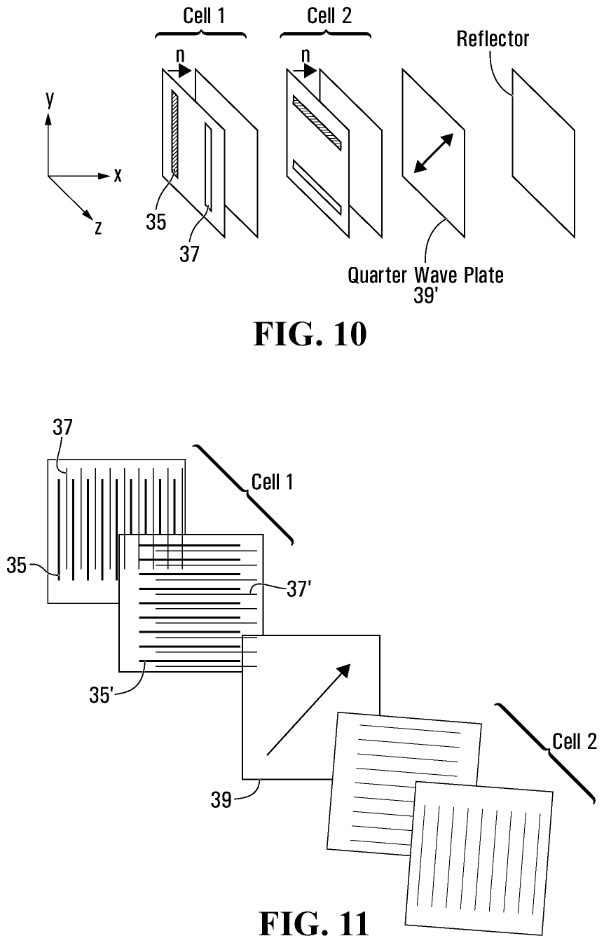

In the ground state of the device, using a homeotropic alignment, the incident light, going through the LC device, will be of “ordinary” polarization mode and will thus suffer of less dispersion and less light scattering (see FIG. 9).

As shown in FIG. 4, the basic unit of the homeotropic LC device is composed of two LC cells and a “special” DS HWP 39 with an anisotropic axis that is oriented at 45° (with respect the in-plane-switch electrode pairs). In this embodiment, the electrode 35, 37 pairs of different cells are perpendicular (“vertical” in the input cell and “horizontal” in the output cell), but they can be also parallel, depending upon the desired functions of the device.

In the embodiment of FIG. 4, the y polarization component of the input light (propagating in the direction +x) will not be affected by the first cell (LC cell 1). However, the z polarisation component of the input light will be affected. Indeed, the LC cell 1 of this device (FIG. 4) will focus the z component of the input light polarization (since the pair of electrodes 35 and 37 is oriented parallel to y axis). This will further broaden the z component in the “horizontal” plane xz

Then, after traversing the HWP 39, both input polarisation components (z and y) will be rotated by 90° (by the HWP 39) and the original z polarization component will be again affected (focused and broaden in the “vertical” plane xy) by the LC cell 2. The original y polarization component will not be affected by the second LC cell neither. Thus, this device may be used to broaden linear polarized (in the z direction) light in two planes (xz and xy). Additionally, the color separation may be significantly less, compared to a prior art LC device, when the DS HWP 39 has poor HWP characteristics in the blue light spectrum (as described herein at FIGS. 2 and 3A to 3C). However, the original y component of light will not be affected and thus we shall observe a “hot spot in the center of the beam that is often undesired.

It will be appreciated that if the LC beam broadening device had a LC material that broadened red light more than blue and green light, then the HWP could be designed to favor the rotation of the polarization of blue and green light with reduced rotation of red light to result in the same CCT stabilizing effect.

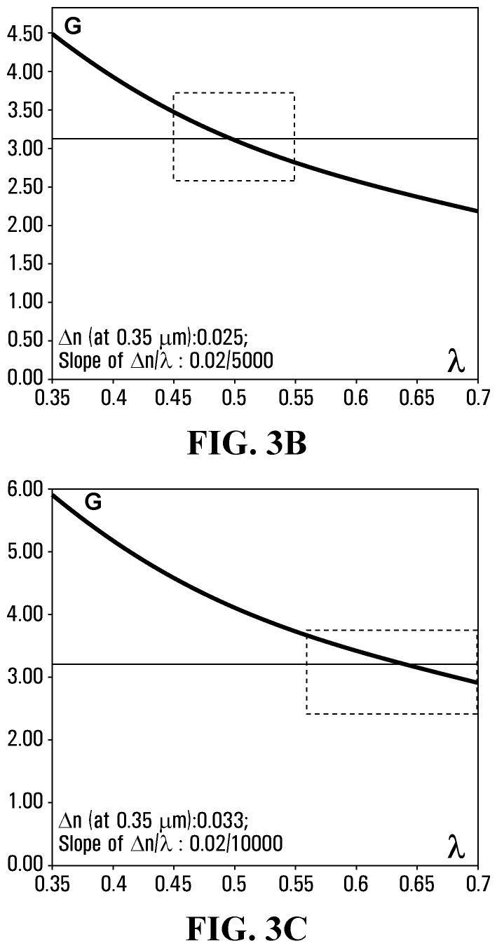

FIG. 5 is another embodiment of an exemplary LC beam control device comprising two homeotropic liquid cells and a central DS HWP 39. This embodiment is an alternative assembly of the embodiment presented in FIG. 4, with the electrodes 35, 37 being in the same orientation for both LC cells.

In this embodiment, the original y polarization of light (propagating in the direction +x) will not be affected by the first LC cell. However, the z polarisation of light will be affected (focused and broaden in the “horizontal” plane xz) by the first LC cell. Then, after traversing the HWP 39, both polarisations will be rotated at 90° by the HWP 39. Thus, the original z polarization will now be vertically oriented and will not be affected by the second LC cell whereas the original y polarization component will become parallel to the z axis and will thus be focused and broaden in the same “horizontal” plane xz by the second LC cell. The LC device of this embodiment may therefore be used to stretch (broaden) both polarizations of light (allowing to work with an unpolarised light source) in one plane (xz). Additionally, the color separation may be significantly less, compared to a prior art LC device, when the DS HWP 39 has poor HWP characteristics in the blue light spectrum.

It will be understood by a person skilled in the art that the embodiments presented in

FIGS. 4 and 5 describe the broadening of a light beam for one or both polarization components and that different electrodes arrangement on the LC cells substrates may be used to broaden the one or more polarisation of a light beam in one or more desired planes.

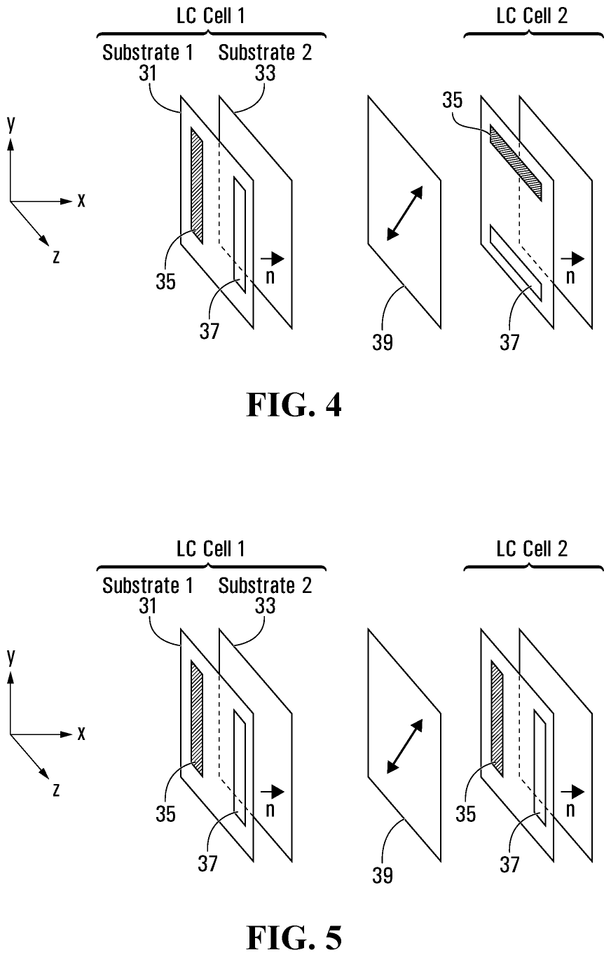

FIG. 6 illustrates yet another embodiment of an exemplary LC beam control device comprising four homeotropic LC cells and a central DS HWP 39. This LC beam control device configuration operates similarly to the ones described in FIGS. 4 and 5 but allows the broadening of an unpolarized light in two planes.

In this embodiment, the original z polarization of light (propagating in the direction +x) will be affected (focused and broaden in the plane xz) by the Cell 1, while the original y polarization of light will be affected (focused and broaden in the plane xy) by the Cell 2. Thus, each polarization component will be broaden in one specific plane (defined by the orientation of finger electrodes).

Then, after traversing the HWP 39, both polarisations will be rotated at 90° by the HWP 39 and the original z polarization component of light will become parallel to the y axis and will thus be affected (focused and broaden in the plane xy) by the Cell 4. In the same time, the original y polarization component now be parallel to the z axis and thus will be affected (focused and broaden in the plane xz) by the Cell 3.

Thus, this device may be used to stretch (broaden) both polarizations of light (i.e. working with an unpolarised light source) in both planes (xz and/or xy). Obviously, different pairs of electrodes may be activated in different cells in an individual way, thus allowing the LC device to perform more sophisticated functions.

Namely, if only the electrodes of the cell 1 are activated, only the input z polarization will be affected and broadened in the plane xz. Similarly, activating electrodes of the Cell 1 and Cell 3 would result in the broadening of both input polarization components (along y and z) in the same xz plane.

Alternatively, broadening light in the xy plane may be done by powering the electrodes of the Cell 2 and Cell 4. These electrodes being the only working electrodes in each LC cell, as well as being individually controllable with this device, it may be possible to start from a circular beam and create various shapes (larger circular, linear, rectangular, etc.).

The use of homeotropic LC cells in the device may improve the dispersion and scattering compared to the planar aligned case of the prior art (e.g. FIG. 1A) as the incident light has an ordinary polarization for which the dispersive properties as well as the scattering are reduced. However, if appropriate electrodes and driving techniques are used, then the use of a homeotropic LC cell structure can also help to reduce the time needed to come back to the original orientation, compared to the natural relaxation (i.e. the time it takes for LC molecules to revert to their initial alignment after the electrodes have been cycled back to an unpowered state).

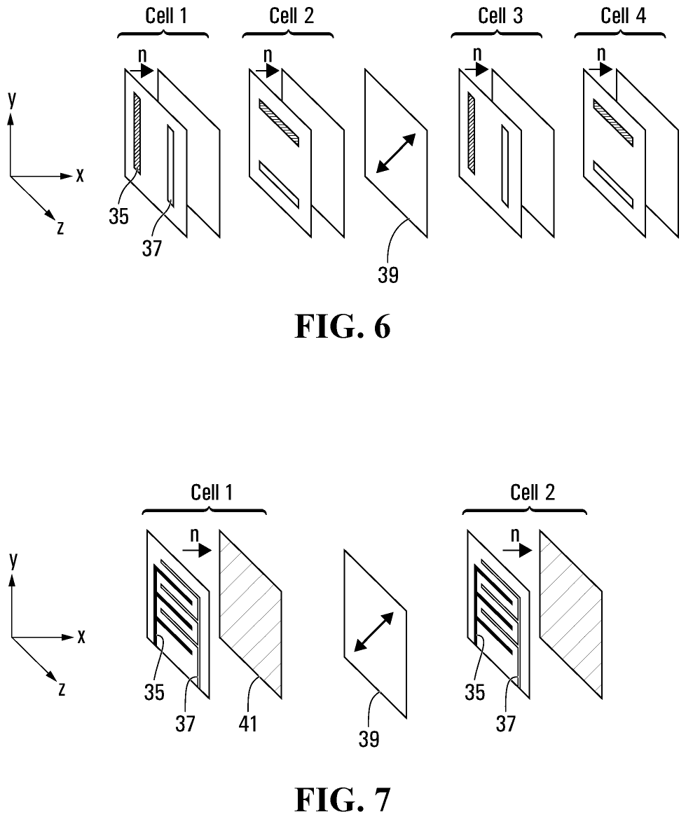

Namely, FIG. 7 is a schematic diagram of an exemplary LC beam control device comprising two homeotropic LC cells, each having interdigitated finger electrodes on one substrate and a uniform transparent electrode 41 on the substrate of the opposing side of the same LC cell, and a center HWP.

Thus, in order to speed this relaxation process, thus decreasing the operative time of the device, a uniform transparent electrode 41 may be added on the second substrate of each LC cell, as shown in the embodiment of FIG. 7. In this case, applying the same (for example, high U) electric potential on electrodes 35, 37 (U1=U2=Uh) of the first substrate, and, at the same time, a different potential (for example, U=U10) on the uniform transparent electrode 41 of the second substrate, allows the LC cell to quickly come back to the original homeotropic alignment.

Although the obtained field may not be perfectly uniform, this may still help to force the director of the LC back to the homeotropic orientation. This results in a “forced relaxation” instead of a natural relaxation and provides significant transition time benefits.

The applicant has characterized this transition time difference between natural and forced relaxation and has found that forced relaxation may decrease the transition time by up to 50% for rather moderate voltages V=Uh−U1=10 Volts. For example, using an exemplary LC beam control device, such as illustrated in FIG. 7, a test resulted in a natural relaxation time of 0.46 seconds (i.e. when the uniform transparent electrode 41 is not used and the voltage, between electrodes 35 and 37 is simply removed). Comparatively, applying a voltage between the electrodes 35, 37 (with the same electric potential) and the uniform transparent electrode 41 resulted in a transition time of 0.24 seconds. It will be understood by those skilled in the art that lower transition times may be achieved by using higher voltages.

Therefore, using a uniform transparent electrode 41 on the opposed substrate as the electrodes 35, 37 in addition to a DS HWP 39 in a homeotropic LC beam control device may significantly reduce the transition time of the LC cells.

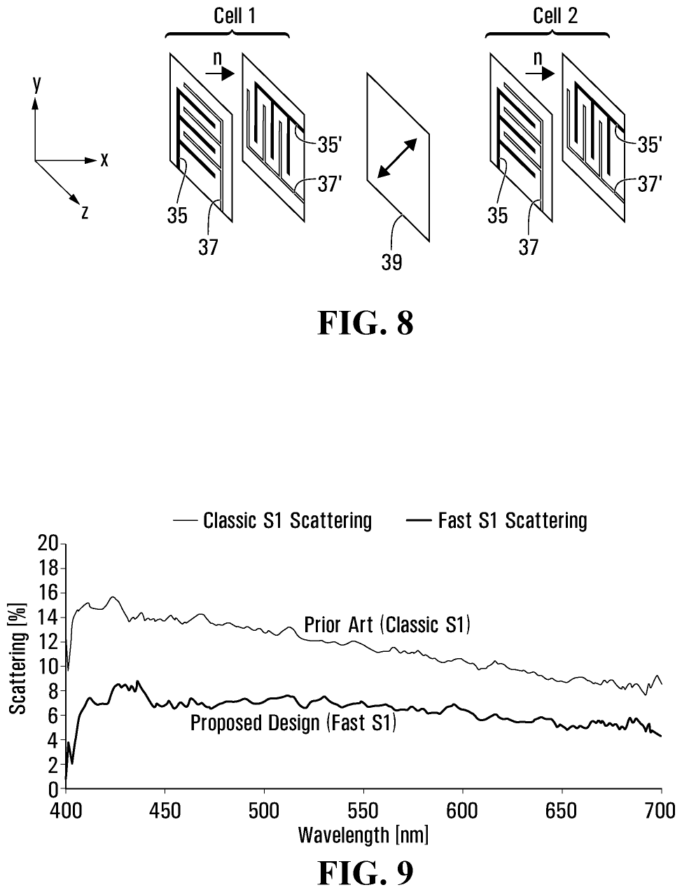

FIG. 8 is a schematic of an exemplary LC beam control device similar to that of FIG. 7's embodiment. This embodiment comprises two homeotropic LC cells with reciprocating electrodes 35, 37 on both substrates of each cell (instead of a uniform transparent electrode on one substrate) and further includes a center HWP 39.

In this embodiment, to accelerate the “relaxation”, the same (for example, high) electric potential can be applied on electrodes 35, 37 (U1=U2=Uh) on the first substrate of the cell, and, in the same time, a different electric potential (for example, low, U=0) on two electrodes 35′, 37′ of the opposed substrate (U3=U4=0). As such, the obtained electric field will be even less uniform inside the cell, but even that will help to reduce the time needed to go back to the original homeotropic alignment. Once the main part of the relaxation is obtained, the electric field can be completely removed to obtain the real ground state.

In addition, this embodiment (of FIG. 8) allows the individual control of electrodes of each substrate in order to perform specific additional functions (e.g., generating various forms of broadened beam). For example, broadening light only in one (say xz or horizontal) plane may be done by activating only the electrode pairs 35′, 37′ that are on the second (or exit) substrates of each LC cell. In this case, the input light with original z polarization component will be broadened in the xz plane by the Cell 1, will then be rotated at 90 degrees by the HWP 39 and will not be affected by the Cell 2. In the same time, the original y polarization component will not be affected by the Cell 1, will be rotated at 90 degrees by the HWP 39 and will then be broaden in the same xz plane by the action of electrodes 35′, 37′ on the second substrate of the Cell 2. Thus, both polarization components of the input light will be broadened (or angularly stretched) in the horizontal (xz) plane.

Alternatively, a similar one-plane broadening of unpolarised light may be achieved in the perpendicular direction (in the vertical or xy plane) by using only the electrodes 35, 37 that are on the first (or entrance) substrates of both cells (FIG. 8).

It is interesting to mention that the situation will be different if we activate all electrodes simultaneously or with shifted phases, such as 0 & 180 at the entrance substrates and 90 and 270 on exit substrates. In this case, the original y (vertical) polarization component of the input beam will be broadened in the vertical xy plane by the lens structures created by the entrance slices of the LC of the Cell 1 (due to the electrodes 35, 37), will then rotate gradually (approximately at 90 degrees) while propagating inside the Cell 1, before reaching the exit substrate (with electrodes 35′, 37′) and will then be broadened in the horizontal xz plane by the exit slices of the same Cell 1. Thus, the Cell 1 will broaden the original y polarization components in two planes. Further more, this polarization component (original y) will be rotated at 90 degrees by the HWP 39 and the same broadening process will be performed by the Cell 2. Thus, the original y polarization component will be twice broadened in both planes. In contrast, the original horizontal (or z) polarization component will not be noticeably affected by the entire device. Thus, we shall observe an intensity hot spot in the center of the transmitted beam.

Therefore, using electrodes on each (entrance and exit) substrate of the LC cells, in addition to a DS HWP 39 in a homeotropic LC beam control device, may not only significantly reduce color separation but may further reduce the light scattering in the ground state and the transition time of the LC cells.

As described herein, using a homeotropic LC cell structure helps to reduce the ground state scattering of the light beam. FIG. 9 is an experimental graph illustrating the reduction in scattering between a prior art device and the proposed design in this application, throughout the visible light spectrum. FIG. 9 shows a “prior art (classic S1)” and a “proposed design (fast S1)” curve. The prior art demonstrates the scattering for a prior art LC beam control device in a configuration as described in FIG. 1A, whereas the proposed design curve shows the scattering for a device using a homeotropic LC cell structure. As clearly observable from the graphic, the new design has significantly less scattering (up to 10% less scattering in the blue light wavelength spectrum). In addition, it is further possible to see the effect of reduced dispersion (the difference of scattering between blue and red light) which is noticeably reduced in the new design.

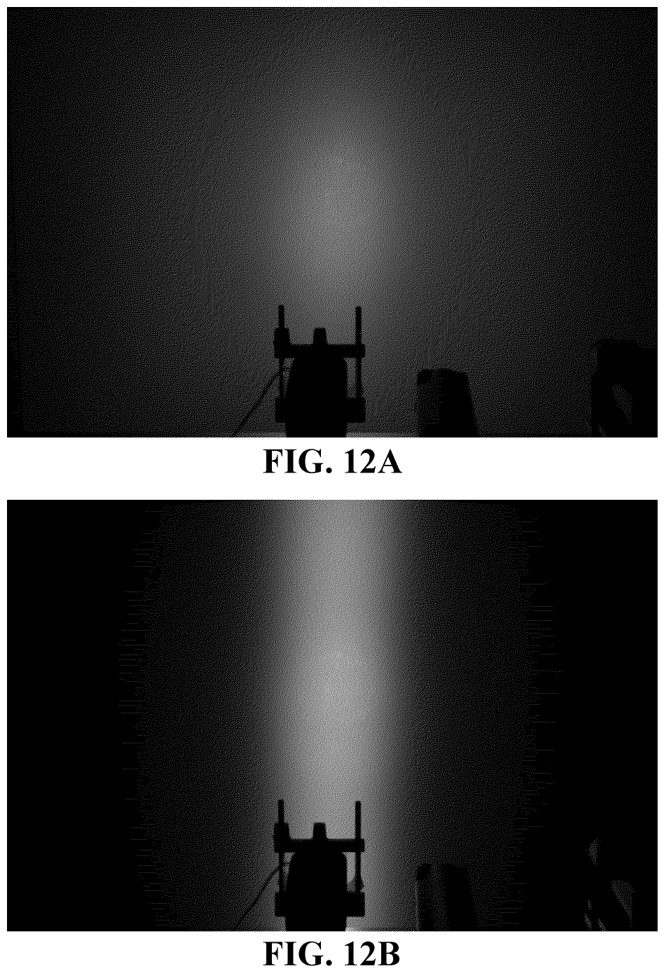

While the above-described embodiment all operate in a transmission mode, it will be appreciated that a suitable quarter wave plate 39′ can be substituted for the HWP and a reflector can be substituted for the second LC cell to provide for beam broadening in a reflection mode. A reflection mode embodiment is illustrated in FIG. 10. Such a reflection mode device can be used to redirect a source beam towards a desired target area while providing beam broadening. Upon the reflection, light beam propagates twice through the quarter wave plate and thus a HWP functionality is obtained with consequences described above.

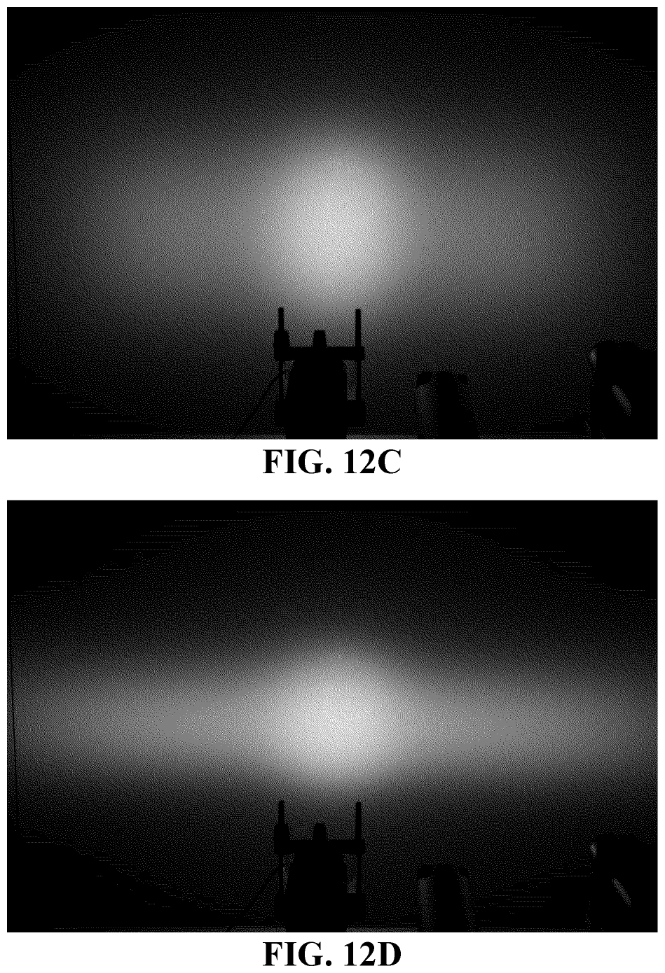

Now referring to FIG. 11 which is a schematic of an exemplary LC beam control device comprising two homeotropic LC cells each having two substrates with perpendicular finger (linear, interdigitated) electrode directions, a half wave plate 39 between the two homeotropic LC cells and a rotation in the alignment of the second homeotropic LC cell. In such embodiment, the second LC cell may be rotated by more than 90° compared to the first LC cell. The additional rotation may be of about +/−2.5°, such that the second LC cell may have a rotation of about 92.5° compared to the first LC cell. Similar to other embodiments described herein, each LC cell substrates may have interdigitated linear electrodes and a different perpendicular orientation. For example, the first substrate of the first LC cell may have generally vertical interdigitated electrodes 35, 37 whereas the second substrate of the first LC cell may have generally horizontal (i.e. perpendicular to the electrodes on the first substrate) interdigitated electrodes 35′, 37′. Doubling up on the number of cells can increase the beam modulation, and the approximately 2.5 degree rotational offset can reduce beam artefacts, namely improve the smoothness of the beam intensity profile.

The second LC cell may have a similar substrate structure as the one described for the first LC cell. In the embodiment of FIG. 11, there may be an HWP 39 included between the first and the second LC cells. As such, it may be possible to steer and/or broaden a beam in any direction by the activation of some or all electrodes.

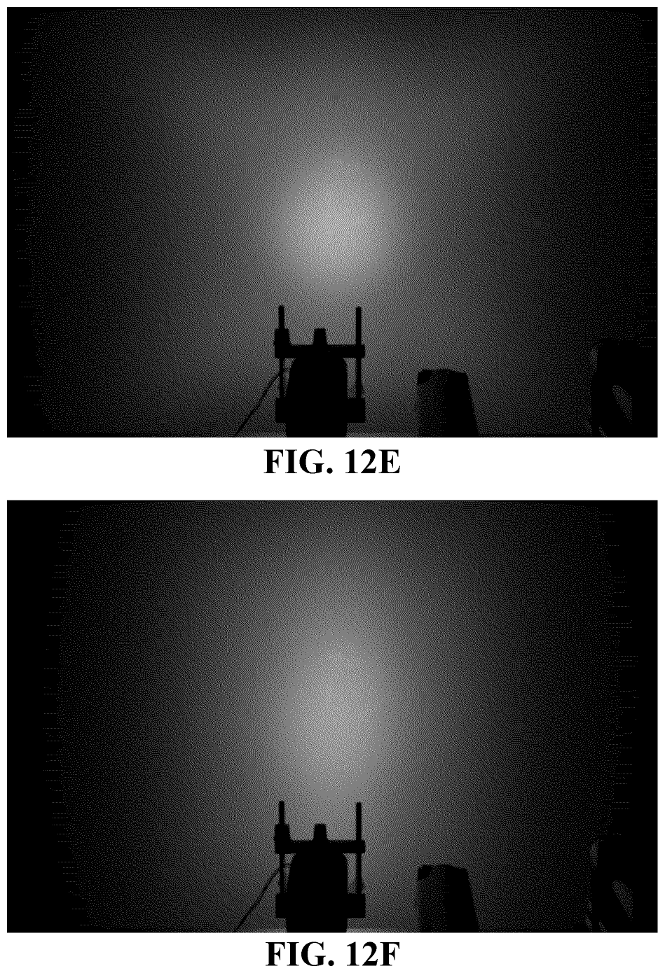

FIG. 12 is a composite illustration of beam broadening in different directions as produced by the exemplary LC beam control device of FIG. 11. FIG. 12A shows equally strong (i.e. 10 V) broadening in both directions, FIG. 12B shows broadening in the Y direction (i.e. 10 V) and no broadening in the X direction, FIG. 12C shows 5 V applied in the X direction with 2.5 V applied in the Y direction, FIG. 12D shows 10 V applied in the X direction and 0 V in the Y direction, FIG. 12E shows equally weak broadening (i.e. 3 V) in both directions, and FIG. 12F shows 2.5 V applied in the X direction and 5 V applied in the Y direction.

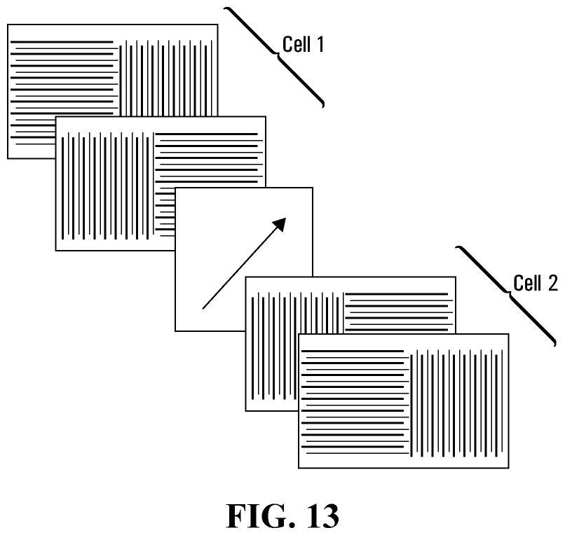

Now referring to FIG. 13 which is a schematic of an exemplary LC beam control device comprising two homeotropic LC cells each having two substrates with dual perpendicular electrode zones and an HWP between the first and the second LC cells. In order to improve symmetry in a broadened or steered light beam, substrates with more than one active zone may be used. The embodiment of FIG. 13 illustrates contiguous dual-zones substrates with electrodes disposed perpendicularly between the zones. Additionally, the second substrate of an LC cell may also have spatially matching dual zones with a perpendicular electrode orientation compared to its matching zone on the first substrate (e.g. a first zone in the first substrate may have horizontal electrodes and its matching first zone in the second substrate may have vertical electrodes). As described herein, the electrodes may be interdigitated, and the second LC cell may be rotated by more than 90° compared to the first LC cell (e.g. it may be rotated by around 92.5° or 87.5°).

Those skilled in the art would appreciate that substrates may have any number of zones without departing from the teachings of this disclosure.

What is claimed is:

1. A liquid crystal (LC) beam modulation device comprising:
at least one tunable LC cell assembly having an LC material whose index of refraction is variable within the visible spectrum such that beam modulation has a first wavelength dependence; and
a polarization rotation element having a second wavelength dependence of efficiency of rotation that is contrary to said first wavelength dependence.

2. The device as defined in claim 1, wherein said polarization rotation element is a half wave plate (HWP), and said at least one tunable LC cell assembly comprises at least two tunable LC cells arranged on opposite sides of said HWP.

3. The device as defined in claim 2, wherein two tunable LC cells are arranged on each side of said HWP.

4. The device as defined in any one of claim 1, 2 or 3, wherein said at least one tunable LC cell contains homeotropically aligned LC material and an arrangement of electrodes that, when powered, cause the LC material to change its refractive index.

5. The device as defined in claim 1, wherein said polarization rotation element is a quarter wave plate, further comprising a reflector for reflecting light passing through said quarter wave plate back through said quarter wave plate and then back through said at least one tunable LC cell.

6. The device as defined in any one of claims 2 to 5, wherein two of said at least two tunable LC cells are oriented at about 92.5 or 87.5 degrees between one another.

7. The device as defined in any one of claims 1 to 6, wherein said at least one tunable LC cell assembly comprises at least two contiguous zones operable to act on at least two different light polarity.

8. The device as defined in any one of claims 1 to 7, wherein said device is configured to broaden a light beam.

9. The device as defined in claim 8, wherein said device is configured to broaden said light beam in one direction.

10. The device as defined in claim 8, wherein said device is configured to broaden said light beam in two directions simultaneously.

11. The device as defined in claim 8, wherein said device is configured to broaden said source light beam in a selected one of two directions.

12. The device as defined in claim 8, wherein said device is configured to broaden only one light polarization.

13. The device as defined in claim 8, wherein said device is configured to broaden two light polarizations.

14. The device as defined in claim 8, wherein said device is configured to switch the electric potential dynamically on each electrode pairs and accelerate the back transition time, by applying a difference of potential between two substrates of the same LC cell.
